(19) United States
(12) Patent Application Publication
(10) Pub. No.: US 2009/0234080 A1
(43) Pub. Date: Sep. 17, 2009

(54) PROCESS FOR PRODUCING LATENT CATALYST AND EPOXY RESIN COMPOSITION

(75) Inventor: Yoshiyuki Goh, Tokyo (JP)

Correspondence Address: DITTHAVONG MORI & STEINER, P.C., 918 Prince St., Alexandria, VA, 22314, US

(73) Assignee: SUMITOMO DAKELITE CO., LTD., Tokyo (JP)

(21) Appl. No.: 12/088,198

(22) PCT Filed: Feb. 27, 2006
(86) PCT No.: PCT/JP2006/303632

§ 371 Date: Mar. 26, 2008

(51) Int. Cl. C08L 63/00; B01J 31/02

(52) U.S. Cl. 525/523; 502/164

(57) ABSTRACT

An object of the invention is to provide a preparation process of a latent catalyst that can gives a latent catalyst, which can exert an excellent catalytic activity at the time of molding and therefore, can provide a resin composition having good curing property, fluidity and storage stability, in a short time in a high yield without mixing in ionic impurities. The present invention relates to a preparation process of a phosphonium silicate latent catalyst, comprising reacting (A) a proton donor represented by the following formula (1):

[Chemical Formula 1]

HY¹-Z¹-Y²H (1)

[wherein Y¹ and Y² may be the same or different and each represents a group resulting from a proton donating substituent through release of a proton, Z¹ represents a substituted or unsubstituted organic group which bonds to the proton donating substituents Y¹H and Y²H, and two substituents Y¹ and Y² in the same molecule are capable of bonding to a silicon atom to form a chelate structure], (B) a trialkoxysilane compound and (D) a phosphonium salt compound represented by the following formula (2):

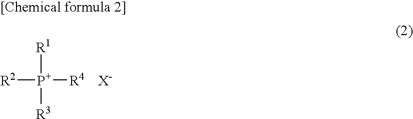

[wherein R¹, R², R³ and R⁴ may be the same or different and each represents an organic group having a substituted or unsubstituted, aromatic or heterocyclic ring or represents a substituted or unsubstituted aliphatic group and X⁻ represents a halide ion, a hydroxide ion or an anion resulting from a proton donating group through release of a proton], wherein the reaction is carried out in the presence of (C) a metal alkoxide compound.

### TECHNICAL FIELD

The present invention relates to a preparation process of a latent catalyst and to an epoxy resin composition.

### BACKGROUND ART

As a method of producing semiconductor devices by encapsulating a semiconductor element such as IC or LSI, transfer molding with an epoxy resin composition has been employed widely because it is low in cost and suited for mass production. The characteristics and the reliability of semiconductor devices are being heightened by improving an epoxy resin or a phenolic resin serving as a curing agent therefor.

With the recent market tendency toward small-sized, lightweight and high-performance electronic appliances, however, the degree of integration of semiconductors for such appliances is increasing year by year, and surface mounting of semiconductor devices is promoted. Under such a tendency, demands for epoxy resin compositions to be used in encapsulating semiconductor chips therewith have been much severer. Accordingly, there have occurred some problems that could not be solved (dealt with) by conventional epoxy resin compositions.

In recent years, materials used for encapsulating semiconductor chips therewith are required to have fluidity high enough not to be impaired by an inorganic filler to be added thereto in a large amount, for the purpose of improving the rapid curability thereof to heighten the production efficiency and for the purpose of improving the heat resistance and the reliability of encapsulated semiconductors.

An addition reaction product of a tertiary phosphine and a quinone is added to epoxy resin compositions for use in the field of electric and electronic materials as a curing accelerator having an excellent rapid curability in order to accelerate the curing reaction of the resin at the time of curing (see, for example, Patent Document 1).

The curing accelerator of such a type may exhibit its curing acceleration effect even at relatively low temperatures. Therefore, the curing reaction is, though slightly, accelerated even in the initial stage thereof, and because of this reaction, the resin component in the resin composition comes to have an increased molecular weight. Such an increase in the molecular weight raises the resin viscosity. As a result, the resin composition containing a large amount of a filler for reliability improvement causes problems such as molding defects due to lack of fluidity.

For improving the fluidity of the curing accelerator, various attempts have heretofore been made to protect a reactive substrate by using a component capable of suppressing the curing property. For example, a study has been made for protecting the active site of a curing accelerator with an ion pair to give latency, and a variety of latent catalysts having a salt structure of an organic acid and a phosphonium ion are known (see, for example, Patent Documents 2 and 3). In such latent catalysts having an ordinary salt structure, however, a curing-suppressing component exists in the salt structure throughout from the initial stage to the end stage of curing reaction so that they cannot attain a sufficient curing property though can attain fluidity. This means that such latent catalysts cannot simultaneously satisfy both the fluidity and the curing property.

In recent years, studies have been made on latent catalysts capable of showing desirable behaviors to satisfy both the curing property and flow characteristics at the time of molding as a curing accelerator of a thermosetting resin such as epoxy resin. It is described that onium salts having a chelate structure can attain both the storage stability and curing property/fluidity at the time of molding, thus showing desired behaviors (see, for example, Patent Document 4).

As a synthesis process of such onium salts having a chelate structure, a process of removing sodium from the sodium salt of a chelate type anion, which sodium salt is obtained by a neutralization reaction using a metal hydroxide, and forming a halogen salt in water or a mixture of water and an organic solvent is conventionally known (see, for example, Patent Document 5). When this synthesis process is applied to the synthesis of a phosphonium silicate salt having a chelate structure, water by-produced upon neutralization by a metal hydroxide or water in a solution brings about hydrolysis/polycondensation of a raw material trialkoxysilane under such alkali conditions, thereby generating a siloxane polymer as a by-product. This leads to difficulty in obtaining the target phosphonium silicate salt at a high purity in a high yield.

Patent Document 1: JP 10-025335 A (page 2)

Patent Document 2: JP 2001-98053 A (page 5)

Patent Document 3: U.S. Pat. No. 4,171,420 (pages 2 to 4)

Patent Document 4: JP 11-5829 A (pages 3 to 4)

Patent Document 5: JP 2003-277510 A (pages 5 to 6)

### DISCLOSURE OF THE INVENTION

### Problems to be Solved by the Invention

An object of the present invention is to provide a process of preparing, in a high yield, a latent catalyst capable of providing a resin composition exhibiting a good curing property and fluidity at the time of molding and also providing a high quality molded product, particularly a molded product having excellent moisture resistance reliability.

### Means for Solving the Problems

With a view to overcoming the above-described problem, the present inventors have proceeded with an extensive investigation. As a result, they have obtained the following findings and completed the present invention.

They have found that when a phosphonium silicate latent catalyst is prepared by reacting a proton donor having a group capable of bonding to a silicon atom to form a chelate structure, a trialkoxysilane compound and a phosphonium salt, the reaction carried out in the presence of a metal alkoxide enables high-yield preparation of the latent catalyst capable of providing a resin composition exhibiting a good curing property and fluidity at the time of molding and also providing a high quality molded product, particularly a molded product having excellent moisture resistance reliability.

Described specifically, the object of the present invention has been achieved by the following inventions (1) to (7).

(1) A preparation process of a phosphonium silicate latent catalyst, which comprises reacting (A) a proton donor represented by the following formula (1):

### [Chemical Formula 1]

HY¹-Z¹-Y²H (1)

[wherein Y¹ and Y² may be the same or different and each represents a group resulting from a proton donating substituent through release of a proton, Z¹ represents a substituted or unsubstituted organic group which bonds to proton donating substituents Y¹H and Y²H, and two substituents Y¹ and Y² in the same molecule are capable of bonding to a silicon atom to form a chelate structure], (B) a trialkoxysilane compound and (D) a phosphonium salt compound represented by the following formula (2):

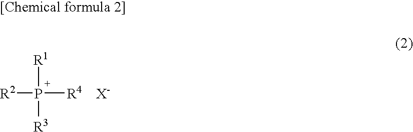

[wherein R¹, R², R³ and R⁴ may be the same or different and each represents an organic group having a substituted or unsubstituted, aromatic or heterocyclic ring or represents a substituted or unsubstituted aliphatic group and X⁻ represents a halide ion, a hydroxide ion or an anion resulting from a proton donating group through release of a proton], wherein the reaction is carried out in the presence of (C) a metal alkoxide compound.

(2) The preparation process of a phosphonium silicate latent catalyst according to (1), wherein the proton donor (A) represented by the formula (1) and the trialkoxysilane compound (B) are allowed to react in advance in an organic solvent in the presence of the metal alkoxide compound (C).

(3) The preparation process of a phosphonium silicate latent catalyst according to (1) or (2), wherein the proton donor (A) represented by the formula (1) is an aromatic dihydroxy compound represented by the following formula (3):

### [Chemical Formula 3]

HO-Ar¹-OH (3)

[wherein Ar¹ represents an organic group having a substituted or unsubstituted, aromatic or heterocyclic ring and two oxygen anions resulting from two OH groups on the organic group Ar¹ through release of a proton are capable of bonding to a silicon atom to form a chelate structure].

(4) The preparation process of a phosphonium silicate latent catalyst according to any one of (1) to (3), wherein the phosphonium salt compound (D) represented by the formula (2) is a quaternary phosphonium salt compound represented by the following formula (4):

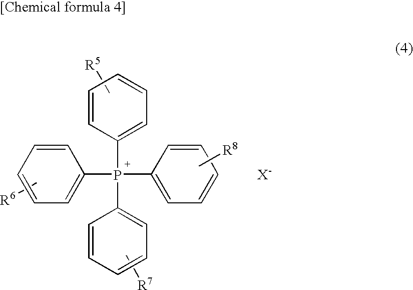

[wherein R⁵, R⁶, R⁷ and R⁸ may be the same or different and each presents one member selected from hydrogen atom, methyl group, methoxy group and hydroxyl group, and X⁻ represents a halide ion, a hydroxide ion or an anion resulting from a proton donating group through release of a proton].

(5) The preparation process of a phosphonium silicate latent catalyst according to any one of (1) to (4), wherein the phosphonium silicate latent catalyst is a phosphonium silicate compound represented by the following formula (5):

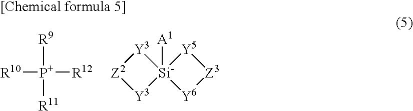

[wherein R⁹, R¹⁰, R¹¹ and R¹² may be the same or different and each represents an organic group having a substituted or unsubstituted aromatic or heterocyclic ring, or a substituted or unsubstituted aliphatic group, Y³, Y⁴, Y⁵ and Y⁶ each represents a group resulting from a proton donating substituent through release of a proton, Z² represents a substituted or unsubstituted organic group which bonds to Y³ and Y⁴, two substituents Y³ and Y⁴ in the same molecule are capable of bonding to a silicon atom to form a chelate structure, Z³ represents a substituted or unsubstituted organic group which bonds to Y⁵ and Y⁶, and two substituents Y⁵ and Y⁶ in the same molecule are capable of bonding to a silicon atom to form a chelate structure, and A¹ represents an organic group].

(6) The preparation process of a phosphonium silicate latent catalyst according to any one of (1) to (5), wherein the phosphonium silicate latent catalyst is a phosphonium silicate compound represented by the following formula (6):

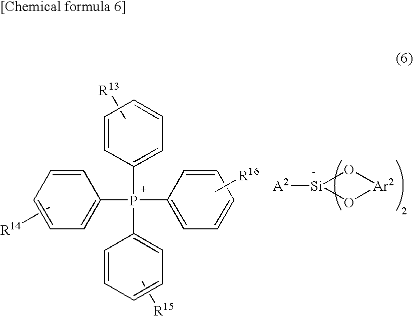

[wherein R¹³, R¹⁴, R¹⁵ and R¹⁶ may be the same or different and each represents one member selected from a hydrogen atom, a methyl group, a methoxy group and a hydroxyl group, Ar² represents an organic group having a substituted or unsubstituted, aromatic or heterocyclic ring, two oxygen anions resulting from two OH groups on the organic group Ar² through release of a proton are capable of bonding to a silicon atom to form a chelate structure, and A² represents an organic group].

(7) An epoxy resin composition comprising (E) a compound having, in one molecule thereof, at least two epoxy group, (F) a compound having, in one molecule thereof, at least two phenolic hydroxyl groups, and (G) a phosphonium silicate latent catalyst obtained by the preparation process as described in any one of (1) to (6).

### ADVANTAGE OF THE INVENTION

The preparation process of a latent catalyst according to the invention makes it possible to prepare a latent catalyst composed of phosphonium silicate in a high yield. The latent catalyst obtained by the invention is extremely useful for the curing acceleration of an epoxy resin. An epoxy resin composition containing the latent catalyst can simultaneously satisfy excellent fluidity, storage stability and curing property.

### BRIEF DESCRIPTION OF THE DRAWING

FIG. 1 is a ¹H-NMR spectrum of reaction product G1.

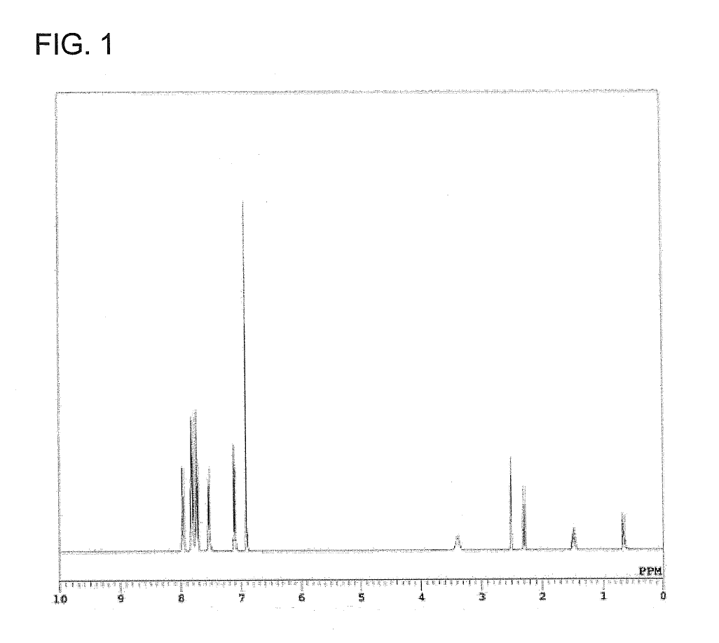

### BEST MODE FOR CARRYING OUT THE INVENTION

Preferred embodiments of the preparation process of a latent catalyst according to the invention will next be described.

The proton donor (A) of the formula (1) to be used in the invention has a compound having, in the molecule thereof, two proton donating substituents which are capable of bonding to a silicon atom to form a chelate structure. One or more of such compounds can be used as the proton donor.

In the compound (HY¹Z¹Y²H) having a proton donating substituent represented by the formula (1), the substituent Z¹ is a substituted or unsubstituted organic group which bonds to the substituent Y¹ and Y², and the substituents Y¹ and Y² in the same molecule are each a group which is resulting from a proton donating substituent through release of a proton and are capable of bonding to a silicon atom to form a chelate structure. The substituents Y¹ and Y² may be the same or different from each other.

Examples of such a substituent Z¹ include an aliphatic organic group such as ethylene and cyclohexylene, an organic group having an aromatic ring such as phenylene, naphthylene and biphenylene, and an organic group having a heterocycle such as pyridinyl and quinoxalinyl. These groups each has, at an adjacent position thereto, the substituents Y¹ and Y². The biphenylene group include, for example, one having the substituents Y¹ and Y² at the 2,2′-positions. Examples of the substituent in the substituted organic group as the substituent Z¹ include aliphatic alkyl groups such as methyl, ethyl, propyl, butyl and hexyl, aromatic groups such as phenyl, alkoxy groups such as methoxy and ethoxy and groups such as nitro, cyano, hydroxyl and halogen.

Examples of the substituents Y¹ and Y² include oxygen atom, sulfur atom and carboxylate group.

Examples of the compound (HY¹Z¹Y²H) of the formula (1) having a proton donating substituent include aliphatic hydroxy compounds such as 1,2-cyclohexanediol, 1,2-ethanediol, 3,4-dihydroxy-3-cyclobutene-1,2-dione and glycerin, aliphatic carboxylic acid compounds such as glycolic acid and thioacetic acid, aromatic hydroxy compounds such as benzoin, catechol, pyrogallol, propyl gallate, tannic acid, 2-hydroxyaniline, 2-hydroxybenzyl alcohol, 1,2-dihydroxynaphthalene and 2,3-dihydroxynaphthalene, and aromatic carboxylic acid compounds such as salicylic acid, 1-hydroxy-2-naphthoeic acid and 3-hydroxy-2-naphthoeic acid.

Of these proton donors, the aromatic dihydroxy compound represented by the formula (3) is more preferred from the standpoints of stability of a silicate anion in the latent catalyst.

In the aromatic dihydroxy compound represented by the formula (3), the substituent Ar¹ represents an organic group having a substituted or unsubstituted, aromatic or heterocyclic ring. Two oxygen anions resulting from two OH groups on the organic group Ar¹ through release of protons are capable of bonding to a silicon atom to form a chelate structure.

Examples of such a substituent Ar¹ include organic groups having an aromatic ring such as phenylene, naphthylene and biphenylene and organic groups having a heterocycle such as pyridinyl and quinoxalinyl. These groups have, at the adjacent position thereto, an OH group. The biphenylene group includes, for example, one having at the 2,2′-positions thereof, an OH group. Examples of the substituent in the organic group having a substituted aromatic or heterocyclic ring as the substituent Ar¹ include aliphatic alkyl groups such as methyl, ethyl, propyl and butyl, aromatic groups such as phenyl, alkoxy groups such as methoxy and ethoxy and groups such as nitro, cyano, hydroxyl and halogen.

Examples of the aromatic dihydroxy compound (HO-Ar¹-OH) represented by the formula (3) include aromatic hydroxy compounds having an organic group with an aromatic ring such as catechol, pyrogallol, propyl gallate, 1,2-dihydroxynaphthalene, 2,3-dihydroxynaphthalene, 1,8-dihydroxynaphthalene, 2,2′-biphenol and tannic acid, and dihydroxy compounds having an organic group with a heterocycle such as 2,3-dihydroxypyridine and 2,3-dihydroxyquinoxaline. Of these, catechol, 2,2′-biphenol, 1,2-dihydroxynaphthalene and 2,3-dihydroxynaphthalene are more preferred from the viewpoint of the stability of a silicate anion in the latent catalyst.

Examples of the trialkoxysilane compound (B) to be used in the invention include trialkoxysilane compounds having a group with a substituted or unsubstituted aromatic ring, trialkoxysilane compounds having a substituted or unsubstituted aliphatic group, and trialkoxysilane compounds having a group with a substituted or unsubstituted heterocycle. The groups having an aromatic ring include phenyl, pentafluorophenyl, benzyl, methoxyphenyl, tolyl, fluorophenyl, chlorophenyl, bromophenyl, nitrophenyl, cyanophenyl, aminophenyl, aminophenoxy, N-phenylanilino, N-phenylanilinopropyl, phenoxypropyl, phenylethynyl, indenyl, naphthyl and biphenyl; the aliphatic groups include methyl, ethyl, propyl, butyl, hexyl, glycidyloxypropyl, mercaptopropyl, aminopropyl, anilinopropyl, butyl, hexyl, octyl, chloromethyl, bromomethyl, chloropropyl, cyanopropyl, diethylamino, vinyl, allyl, methacryloxymethyl, methacryloxypropyl, pentadienyl, bicycloheptyl, bicycloheptenyl and ethynyl; and the groups with a heterocycle include pyridyl, pyrrolinyl, imidazolyl, indonyl, triazolyl, benzotriazolyl, carbazolyl, triazinyl, piperidyl, quinolyl, morpholinyl, furyl, furfuryl and thienyl. Of these, vinyl, phenyl, naphthyl and glycidyloxypropyl groups are more preferred from the viewpoint of the stability of a silicate anion in the latent catalyst. As specific examples of such a trialkoxysilane compound (B), the trialkoxysilane compounds having a group with a substituted or unsubstituted aromatic ring include phenyltrimethoxysilane, phenyltriethoxysilane, pentafluorophenyltriethoxysilane, 1-naphthyltrimethoxysilane and (N-phenylaminopropyl)trimethoxysilane; the trialkoxysilane compounds having a substituted or unsubstituted aliphatic group include methyltrimethoxysilane, methyltriethoxysilane, ethyltrimethoxysilane, ethyltriethoxysilane, hexyltrimethoxysilane, vinyltrimethoxysilane, hexyltriethoxysilane, 3-glycidoxypropyltrimethoxysilane, 3-mercaptopropyltrimethoxysilane and 3-aminopropyltrimethoxysilane; and the trialkoxysilane compounds having a group with the substituted or unsubstituted heterocycle include 2-(trimethoxysilylethyl)pyridine and N-(3-trimethoxysilylpropyl)pyrrole. Examples of the substituent in the aliphatic group include glycidyl, mercapto and amino groups, while those in the aromatic or heterocyclic ring include methyl, ethyl, hydroxyl and amino groups.

Examples of the metal alkoxide compound (C) to be used in the invention include alcoholate compounds of an alkali metal such as sodium methoxide, sodium ethoxide, sodium t-butoxide and potassium butoxide. Of these, sodium methoxide is preferred from the standpoint of cost.

The phosphonium salt compound (D) of the formula (2) to be used in the invention is a quaternary phosphonium salt compound composed of a tetra-substituted phosphonium cation and anion.

In the cation moiety constituting the phosphonium salt compound represented by the formula (2), substituents R¹, R², R³ and R⁴ which bond to a phosphorus atom each represents an organic group having a substituted or unsubstituted, aromatic or heterocyclic ring, or a substituted or unsubstituted aliphatic group. They may be the same or different from each other.

As the substituent R¹, R², R³ or R⁴, the organic group having a substituted or unsubstituted aromatic ring is, for example, phenyl, methylphenyl, methoxyphenyl, hydroxyphenyl, naphthyl, hydroxynaphthyl or benzyl group, while the organic group having a substituted or unsubstituted heterocycle is, for example, furyl, thienyl, pyrrolyl, pyridyl, pyrimidyl, piperidyl, indolyl, morpholinyl, quinolyl, isoquinolyl, imidazolyl or oxazolyl group; the substituted or unsubstituted aliphatic group is, for example, an aliphatic group such as methyl, ethyl, n-butyl, n-octyl or cyclohexyl group. Of these, the substituted or unsubstituted aromatic group such as phenyl, methylphenyl, methoxyphenyl, hydroxyphenyl or hydroxynaphthyl is more preferred from the standpoints of reaction activity in the latent catalyst and stability of a phosphonium cation.

Examples of the substituent in the organic group having a substituted aromatic ring or substituted heterocycle or the substituent in the substituted aliphatic group include aliphatic groups such as methyl, ethyl and propyl, aromatic groups such as phenyl group, alkoxy groups such as methoxy and ethoxy, and groups such as nitro, cyano, hydroxyl and halogen.

In the anion moiety constituting the phosphonium salt compound of the formula (2), X⁻ represents a halide ion, a hydroxide ion or an anion resulting from a proton donating group through release of a proton. Examples of the halide ion include fluoride ion, chloride ion, bromide ion and iodide ion, while those of the anion resulting from a proton donating group through release of a proton include anions of a mineral acid such sulfuric acid and nitric acid, carboxylate anions of an aliphatic or aromatic carboxylic acid such as acetic acid, benzoic acid, biphenylcarboxylic acid and naphthalenecarboxylic acid, oxy anions of a phenol, bisphenol, biphenol or hydroxynaphthalene, thiolate anions of a mercapto compound such as thiophenol and thiocatechol, and sulfonate anions of an organic sulfonic acid such as toluenesulfonic acid and trifluoromethanesulfonic acid.

Specific examples of the phosphonium salt compound include compounds having a halogen anion such as tetra-n-butylphosphonium bromide, ethyltriphenylphosphonium bromide, benzyltriphenylphosphonium bromide, 3-hydroxyphenyltriphenylphosphonium bromide, 2,5-dihydroxyphenyltriphenylphosphonium bromide, tetraphenylphosphonium bromide and tetrakis(4-methylphenyl)phosphonium bromide, compounds having a carboxylate anion such as tetrabutylphosphonium benzoate, and compounds having a phenolate anion such as tetraphenylphosphonium-bisphenol salt.

Of these phosphonium salt compounds, tetraaryl-substituted phosphonium salt molecular compounds which are quaternary phosphonium salt compounds represented by the formula (4) are more preferred from the standpoints of the reaction activity in the latent catalyst and stability of a phosphonium cation.

In the phosphonium cation moiety constituting the quaternary phosphonium salt compound represented by the formula (4), R⁵, R⁶, R⁷ and R⁸ which are substituents bonding to a phenyl group each represents one member selected from hydrogen atom, methyl group, methoxy group and hydroxyl group. They may be the same or different from each other. In the anion moiety constituting the quaternary phosphonium salt compound, the X⁻ represents a halide ion, a hydroxide ion or an anion resulting from a proton donating group through release of a proton. Examples of the halide ion and the anion resulting from the proton donating group through release of a proton are similar to those exemplified above as the anion constituting the phosphonium salt represented by the formula (2).

Specific examples of the quaternary phosphonium salt compound include 3-hydroxyphenyltriphenylphosphonium bromide, 2,5-dihydroxyphenyltriphenylphosphonium bromide, tetraphenylphosphonium bromide, tetrakis(4-methylphenyl)phosphonium bromide and tetraphenylphosphonium-bisphenol salt.

A preparation process of a latent catalyst according to the invention will hereinafter be described.

The preparation process of a latent catalyst according to the invention comprises reacting the proton donor (A) represented by the formula (1), the trialkoxysilane compound (B) and the phosphonium salt compound (D) represented by the formula (2) in the presence of the metal alkoxide compound (C). Examples of it include a process depending on a synthesis route which comprises mixing one or more of the proton donor (A) of the formula (1) with the trialkoxysilane compound (B) in an organic solvent such as alcohol capable of dissolving these compounds therein, adding the metal alkoxide compound (C) directly to the resulting mixture, and then adding and mixing the phosphonium salt compound of the formula (2). Alternatively, in the invention, the proton donor (A), trialkoxysilane compound (B) and phosphonium salt compound (D) may be mixed in the presence of the metal alkoxide compound (C) to synthesize the latent catalyst.

The metal alkoxide compound (C) used here may be in the form of a solution obtained by dissolving it in an organic solvent in advance. The phosphonium salt compound (D) of the formula (2) may be in the form of a solid or a solution obtained by dissolving it in an organic solvent in advance. The phosphonium silicate latent catalyst can be synthesized in a high yield by the above-described preparation process.

The above-described reaction proceeds even in a solventless manner, but it is preferably carried out in an organic solvent from the standpoints of the uniformity of the reaction and yield. The reaction carried out in an alcohol solvent such as methanol, ethanol or propanol is more preferred.

In the above-described reaction, the reaction is preferably carried out with a feed molar ratio of the proton donor (A) to trialkoxysilane compound (B), i.e. (A)/(B), within the range of from 0.5 to 5. From the standpoints of yield and purity, it is more preferred that the ratio is within the range of from 1.5 to 2.5. The reaction is preferably carried out with a feed molar ratio of the proton donor (A) to the metal alkoxide compound (C), i.e., (A)/(C), within the range of from 0.5 to 5. From the standpoints of yield and purity, it is more preferred that the ratio is within the range of from 1.5 to 2.5. The reaction is preferably carried out with a feed molar ratio of the proton donor (A) to the phosphonium salt compound (D), i.e., (A)/(D), of from 0.5 to 5. From the standpoints of yield and purity, it is more preferred that the ratio is within the range of from 1.5 to 2.5.

The reaction proceeds well at room temperature, but the reaction may be carried out under heating in order to prepare a desired latent catalyst efficiently in a short time.

The reaction product obtained by the above-described reaction is able to have improved purity by washing, for purification, with an alcohol solvent such as methanol or ethanol, an ether solvent such as diethyl ether or tetrahydrofuran or an aliphatic hydrocarbon solvent such as n-hexane.

The preparation process of a latent catalyst according to the invention is not limited to the above-described ones, though the above-described synthesis reaction route is common.

The latent catalyst obtained by the above-described preparation process is preferably a phosphonium silicate compound represented by the formula (5).

In the cation moiety constituting the phosphonium silicate compound represented by the formula (5), R⁹, R¹⁰, R¹¹ and R¹² which are the substituents bonding to a phosphorus atom each represents an organic group having a substituted or unsubstituted, aromatic or heterocyclic ring or a substituted or unsubstituted aliphatic group and they may be the same or different from each other.

Examples of these substituents R⁹, R¹⁰, R¹¹ and R¹² are similar to those exemplified above as the substituents R¹, R², R³ and R⁴ in the formula (2). From the viewpoints of the reaction activity in the latent catalyst and stability of a phosphonium cation, they are more preferably organic groups having a substituted or unsubstituted aromatic ring such as phenyl, methylphenyl, methoxyphenyl, hydroxyphenyl and hydroxynaphthyl.

In the silicate anion constituting the phosphonium silicate compound represented by the formula (5), the substituents Y³ and Y⁴ are each a group resulting from the proton donating substituent through release of a proton and the substituents Y³ and Y⁴ in the same molecule bond to a silicon atom to form a chelate structure. The substituents Y⁵ and Y⁶ are each a group resulting from the proton donating substituent through release of a proton and the substituents Y⁵ and Y⁶ in the same molecule bond to a silicon atom to form a chelate structure. The substituents Y³, Y⁴, Y⁵ and Y⁶ may be the same or different from each other. The substituent Z² represents an organic group which bonds to the substituents Y³ and Y⁴, while the substituent Z³ is an organic group which bonds to the substituents Y⁵ and Y⁶

Examples of the substituents Y³, Y⁴, Y⁵ and Y⁶ are similar to those exemplified as the substituents Y¹ and Y² in the proton donor represented by the formula (1), while examples of the Z² and Z³ are similar to those exemplified as the substituent Z¹ in the proton donor represented by the formula (1).

The groups represented by Y³Z²Y⁴ and Y⁵Z³Y⁶ in the silicate anion which constitutes the phosphonium silicate compound represented by the formula (5) are groups resulting from the compounds (HY³Z²Y⁴H and HY⁵Z³Y⁶H) through release of a proton. Examples of them are similar to the groups resulting through release of a proton (H) in the compound (HY¹Z¹Y²H) of the formula (1) having a proton donating substituent. Of these, groups resulting from catechol, 1,2-dihydroxynaphthalene or 2,3-dihydroxynaphthalene through release of a proton are more preferred from the standpoint of the stability of a silicate anion in the latent catalyst.

In the silicate anion constituting the phosphonium silicate compound represented by the formula (5), A¹ represents an organic group having a substituted or unsubstituted, aromatic or heterocyclic ring or a substituted or unsubstituted aliphatic group. Specific examples thereof are similar to the groups having a substituted or unsubstituted aromatic ring, the groups having a substituted or unsubstituted aliphatic group and the groups having a substituted or unsubstituted heterocycle in the trialkoxysilane compound (B). Of these, vinyl, phenyl, naphthyl and glycidyloxypropyl groups are more preferred from the standpoint of stability of a silicate anion in the latent catalyst.

As the latent catalyst available by the above-described preparation process, phosphonium silicate compounds represented by the formula (6) are still more preferred.

In the cation moiety constituting the phosphonium silicate compound represented by the formula (6), R¹³, R¹⁴, R¹⁵ and R¹⁶ which are substituents bonding to a phenyl group are similar to R⁵, R⁶, R⁷ and R⁸ which are the substituents bonding to a phenyl group in the phosphonium cation moiety constituting the quaternary phosphonium salt compound represented by the formula (4).

In the silicate anion moiety constituting the phosphonium silicate compound represented by the formula (6), Ar²'s each represents an organic group having a substituted or unsubstituted, aromatic or heterocyclic ring. Two oxygen anions resulting from two OH groups on the organic group Ar² through release of a proton are capable of bonding to a silicon atom to form a chelate structure.

Examples of the Ar² are similar to those exemplified as Ar¹ in the aromatic dihydroxy compound represented by the formula (3).

The group represented by O-Ar²-O in the phosphonium silicate compound represented by the formula (6) is a group resulting from a compound having a proton donating substituent through release of a proton Examples of it are similar to the above-described groups resulting from the aromatic dihydroxy compound (HO-Ar¹-OH) represented by the formula (3) through release of a proton. Of these, groups resulting from catechol, 2,2′-biphenol, 1,2-dihydroxynaphthalene or 2,3-dihydroxynaphthalene through release of a proton are more preferred from the viewpoint of the stability of a silicate anion in the latent catalyst.

In the silicate anion constituting the phosphonium silicate compound represented by the formula (6), A² represents an organic group having a substituted or unsubstituted, aromatic or heterocyclic ring or a substituted or unsubstituted aliphatic group. Specific examples of them are similar to the groups having a substituted or unsubstituted aromatic ring, the groups having a substituted or unsubstituted aliphatic group and the groups having a substituted or unsubstituted heterocycle in the trialkoxysilane compound (B). Of these, vinyl, phenyl, naphthyl and glycidyloxypropyl groups are more preferred from the standpoint of the stability of a silicate anion in the latent catalyst.

Epoxy resin compositions using the latent catalyst obtained by the invention will next be described.

The epoxy resin composition of the invention contains a compound (E) having, in one molecule thereof, at least two epoxy groups, a compound (F) having, in one molecule thereof, at least two phenolic hydroxyl groups, and a latent catalyst (G) obtained above and it may further contain an inorganic filler (H) optionally.

No particular limitation is imposed on the compound (E) usable in the invention and having, in one molecule thereof, at least two epoxy groups insofar as it has, in one molecule thereof, at least two epoxy groups. Examples of such a compound (E) include bisphenol type epoxy resins such as bisphenol A type epoxy resins, bisphenol F type epoxy resins and brominated bisphenol type epoxy resins, biphenyl type epoxy resins, biphenyl aralkyl type epoxy resins, stilbene type epoxy resins, phenol novolac type epoxy resins, cresol novolac type epoxy resins, naphthalene type epoxy resins, dicyclopentadiene type epoxy resins, dihydroxybenzene type epoxy resins, epoxy compounds prepared by reacting epichlorohydrin with the hydroxyl group of a phenol, phenolic resin or naphthol, epoxy resins prepared by oxidizing an olefin with peracid, followed by epoxidation, glycidyl ester type epoxy resins and glycidyl amine type epoxy resins. These compounds may be used either singly or in combination of two or more thereof.

The compound (F) usable in the invention and having, in one molecule thereof, at least two phenolic hydroxyl groups has, in one molecule thereof, at least two phenolic hydroxyl groups and acts (functions) as a curing agent of Compound (E). Examples of such a compound (F) include phenol novolac resins, cresol novolac resins, bisphenol resins, phenol aralkyl resins, biphenyl aralkyl resins, trisphenol resins, xylylene-modified novolac resins, terpene-modified novolac resins and dicyclopentadiene-modified phenolic resins. These compounds may be used either singly or in combination of two or more thereof.

When the epoxy resin composition of the invention is used for the encapsulation of electronic parts such as semiconductor elements, the inorganic filler (H) which is an optional component is incorporated (mixed) in the epoxy resin composition in order to improve the solder resistance of the resulting semiconductor device. No particular limitation is imposed on the kind of the inorganic filler and those employed ordinarily for encapsulating materials can be used.

Although in the epoxy resin composition containing the latent catalyst obtained by the invention, no particular limitation is imposed on the content (amount) of the latent catalyst (G), it is added preferably in an amount of from about 0.01 to 20 parts by weight, more preferably from about 0.1 to 10 parts by weight per 100 parts by weight of the sum of the compound (E) and the compound (F). By containing the latent catalyst in such an amount, the resulting epoxy resin composition exhibits curing property, storage stability, fluidity and characteristics of the cured product in a well balanced manner.

In addition, there is no particular limitation imposed on the mixing ratio of the compound (E) having, in one molecule thereof, at least two epoxy groups to the compound (F) having, in one molecule thereof, at least two phenolic hydroxyl groups, however, they are mixed so that the amount of the phenolic hydroxyl group of the compound (F) is preferably from about 0.5 to 2 moles, more preferably from about 0.7 to 1.5 moles, per mole of the epoxy group of the compound (E). When the mixing ratios are within the above-described range, the resulting epoxy resin composition is improved in various properties, while maintaining the well balance among various properties.

Although no particular limitation is imposed on the content (amount) of the inorganic filler (H), it is added preferably in an amount of from about 200 to 2400 parts by weight, more preferably from 400 to 1400 parts by weight based on 100 parts by weight, in total, of the compound (E) and compound (F). The content of the inorganic filler (H) may be outside the above-described range. When it is below the lower limit, however, there is a fear of the inorganic filler (H) exhibiting an insufficient reinforcing effect. When it exceeds the upper limit, on the other hand, there is a fear of the epoxy resin composition having deteriorated fluidity and causing poor filling or the like at the molding time of the epoxy resin composition (for example, at the manufacturing time of a semiconductor device).

The contents (amounts) of the inorganic filler (H) falling within a range of from 400 to 1400 parts by weight based on 100 parts by weight, in total, of the compound (E) and the compound (F) are more preferred because the cured product of the epoxy resin composition has lower hygroscopicity and generation of solder cracks can therefore be prevented. The epoxy resin composition containing it in such an amount has good fluidity at the heating and melting time so that gold wire deformation inside of the semiconductor device can be preferably prevented.

The epoxy resin composition of the invention contains the compound (E) having in one molecule thereof at least two epoxy groups, the compound (F) having, in one molecule thereof, at least two phenolic hydroxyl groups, the latent catalyst (G) obtained above and optionally the inorganic filler (H). In addition, if necessary, various additives may be added (incorporated), for example, a coupling agent typified by an alkoxysilane such as 3-glycidyloxypropyltrimethoxysilane, 3-mercaptopropyltrimethoxysilane, N-phenyl-3-aminopropyltrimethoxysilane, 3-ureidopropyltriethoxysilane or phenyltrimethoxysilane, a titanate ester or an aluminate ester; a colorant such as carbon black; a flame retardant such as brominated epoxy resin, antimony oxide, aluminum hydroxide, magnesium hydroxide, zinc oxide or phosphorus compound; a low stress component such as silicone oil or silicone rubber; a natural wax such as carnauba wax; synthetic wax such as polyethylene wax; releasing agent such as higher fatty acid or a metal salt thereof, for example, stearic acid or zinc stearate, or paraffin; an ion catcher such as a magnesium-containing, aluminum-containing, titanium-containing or bismuth-containing ion catcher; and a bismuth antioxidant. Further, the epoxy resin composition of the invention may contain other resins than the above-described compound (E) and compound (F) as resin components to the extent that does not adversely affect the problems to be solved by the invention.

The epoxy resin composition of the invention can be obtained by uniformly mixing the above-described components, and optionally other additives, with a mixer. Alternatively, it can be obtained by kneading the mixture thus obtained at normal temperature under heating by using a kneading machine such as roll, kneader, co-kneader or twin-screw extruder, followed by cooling and grinding. When the epoxy resin composition thus obtained is in the powder form, it may be pressed into tablets by a press in order to improve the workability at the time of using.

When the epoxy resin composition of the invention is used for encapsulating therewith various electronic parts such as semiconductor elements to manufacture a semiconductor device, it may be cured and molded by the conventional molding method such as transfer molding, compression molding or injection molding.

### EXAMPLES

The specific examples of the invention will next be described.

### Example 1

In a separable flask (volume: 500 mL) equipped with a condenser and a stirrer were charged 32.0 g (0.20 mol) of 2,3-dihydroxynaphthalene, 19.6 g (0.10 mol) of 3-mercaptopropyltrimethoxysilane and 150 mL of ethanol and they were dissolved uniformly under stirring. A solution obtained in advance by dissolving 5.40 g (0.10 mol) of sodium methoxide in 20 mL of ethanol was added dropwise into the flask under stirring. Another solution obtained in advance by dissolving 41.9 g (0.10 mol) of tetraphenylphosphonium bromide in 100 mL of ethanol was then gradually added dropwise into the flask to precipitate crystals. The crystals thus precipitated were purified by filtration, washing with water and vacuum drying, whereby Compound G1 was obtained.

Compound G1 was analyzed by ¹H-NMR, mass spectrum and elemental analysis. It has been confirmed by the analysis results that Compound G1 thus obtained was phosphonium silicate represented by the below-described formula (7) The yield of Compound G1 was 91%.

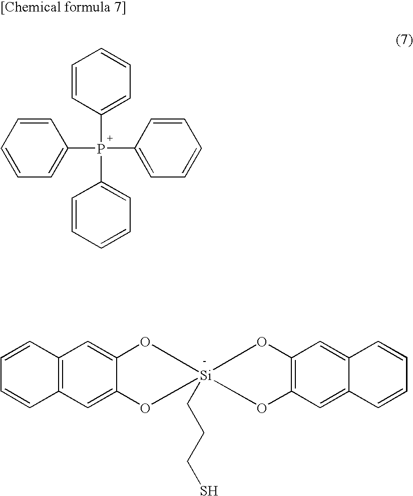

### Example 2

Synthesis was performed in the same manner as in Example 1, except that 23.6 g (0.10 mol) of 3-glycidyloxypropyltrimethoxysilane was used in place of 3-mercaptopropyltrimethoxysilane, whereby Compound G2 was obtained as purified crystals. Compound G2 was analyzed by ¹H-NMR, mass spectrum and elemental analysis. It has been confirmed by the analysis results that Compound G2 thus obtained was phosphonium silicate represented by the below-described formula (8). The yield of Compound G2 was 88%.

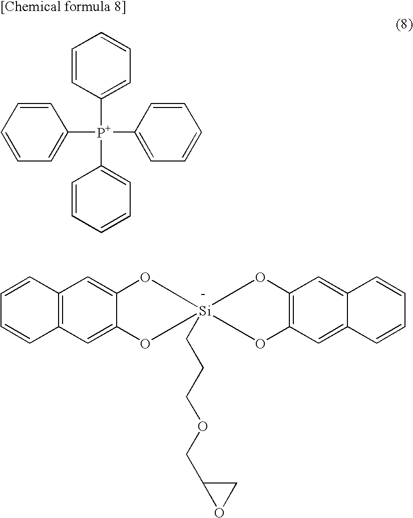

### Example 3

Synthesis was performed in the same manner as in Example 1, except that 43.5 g (0.10 mol) of 3-hydroxyphenyltriphenylphosphonium bromide was used in place of tetraphenylphosphonium bromide, whereby Compound G3 was obtained as purified crystals. Compound G3 was analyzed by ¹H-NMR, mass spectrum and elemental analysis. It has been confirmed by the analysis results that Compound G3 thus obtained was phosphonium silicate represented by the below-described formula (9). The yield of Compound G3 was 89%.

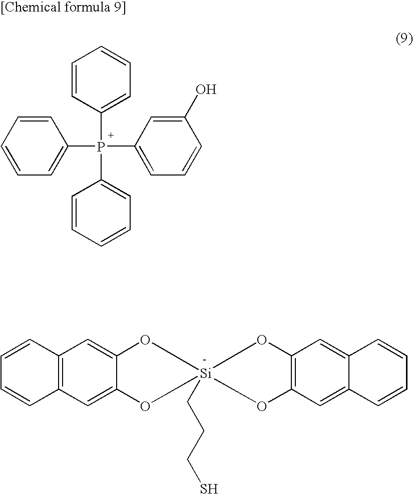

### Example 4

Synthesis was performed in the same manner as in Example 3, except that 19.8 g (0.10 mol) of phenyltrimethoxysilane was used in place of 3-mercaptopropyltrimethoxysilane, whereby Compound G4 was obtained as purified crystals. Compound G4 was analyzed by ¹H-NMR, mass spectrum and elemental analysis. It has been confirmed by the analysis results that Compound G4 thus obtained was phosphonium silicate represented by the below-described formula (10). The yield of Compound G4 was 92%.

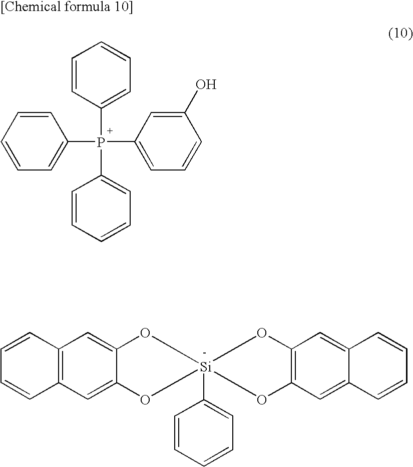

### Example 5

Synthesis was performed in the same manner as in Example 4, except that 40.7 g (0.10 mol) of 2,5-dihydroxyphenyltriphenylphosphonium chloride was used in place of 3-hydroxyphenyltriphenylphosphonium bromide, whereby Compound G5 was obtained as purified crystals. Compound G5 was analyzed by ¹H-NMR, mass spectrum and elemental analysis. It has been confirmed by the analysis results that Compound G5 thus obtained was phosphonium silicate represented by the below-described formula (11). The yield of Compound G5 was 90%.

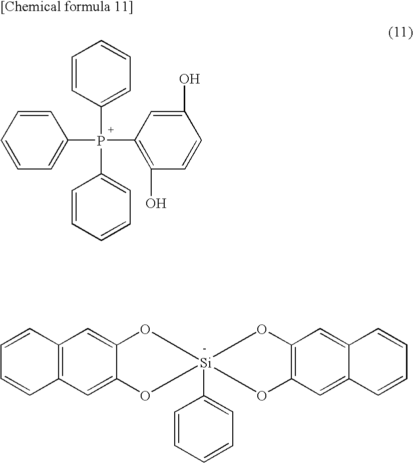

### Example 6

Synthesis was performed in the same manner as in Example 4, except that 41.9 g (0.10 mol) of tetraphenylphosphonium bromide was used in place of 3-hydroxyphenyltriphenylphosphonium bromide, whereby Compound G6 was obtained as purified crystals. Compound G6 was analyzed by ¹H-NMR, mass spectrum and elemental analysis. It has been confirmed by the analysis results that Compound G6 thus obtained was phosphonium silicate represented by the below-described formula (12). The yield of Compound G6 was 96%.

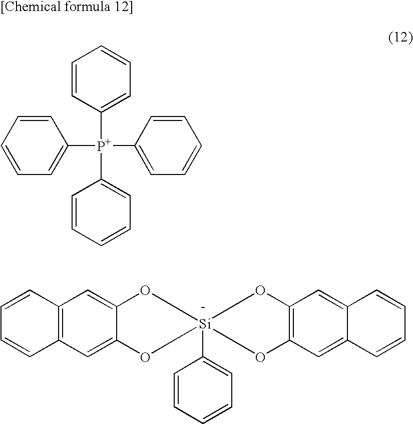

### Example 7

Synthesis was performed in the same manner as in Example 6, except that 22.0 g (0.20 mol) of catechol was used in place of 2,3-dihydroxynaphthalene, whereby Compound G7 was obtained as purified crystals. Compound G7 was analyzed by ¹H-NMR, mass spectrum and elemental analysis. It has been confirmed by the analysis results that Compound G7 thus obtained was phosphonium silicate represented by the below-described formula (13). The yield of Compound G7 was 91%.

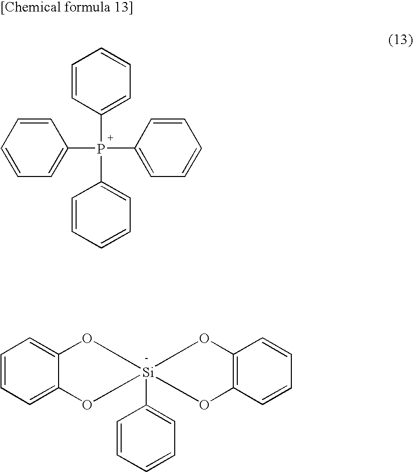

### Example 8

Synthesis was performed in the same manner as in Example 6, except that 32.0 g (0.20 mol) of 1,8-dihydroxynaphthalene was used in place of 2,3-dihydroxynaphthalene and that 24.0 g (0.10 mol) of phenyltriethoxysilane was used in place of phenyltrimethoxysilane, whereby Compound G8 was obtained as purified crystals. Compound G8 was analyzed by ¹H-NMR, mass spectrum and elemental analysis. It has been confirmed by the analysis results that Compound G8 thus obtained was phosphonium silicate represented by the below-described formula (14). The yield of Compound G8 was 90%.

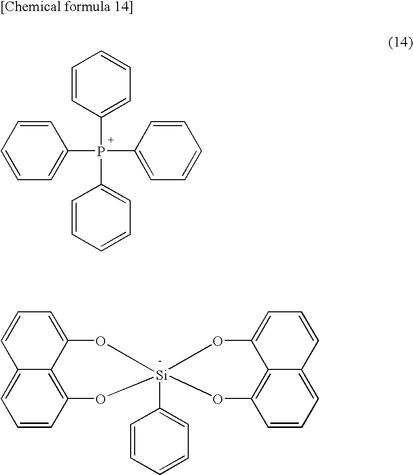

Synthesis was performed in the same manner as in Example 7, except that 24.3 g (0.10 mol) of 1-naphthyltrimethoxysilane was used in place of phenyltrimethoxysilane and that 6.81 g (0.10 mol) of sodium ethoxide was used in place of sodium methoxide, whereby Compound G9 was obtained as purified crystals. Compound G9 was analyzed by ¹H-NMR, mass spectrum and elemental analysis. It has been confirmed by the analysis results that Compound G9 thus obtained was phosphonium silicate represented by the below-described formula (15). The yield of Compound G9 was 89%.

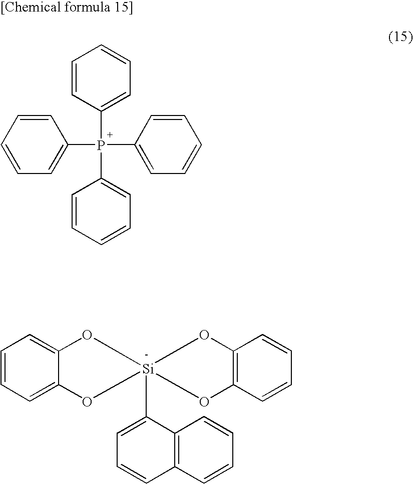

### Example 10

Synthesis was performed in the same manner as in Example 7, except that 25.5 g (0.10 mol) of N-phenyl-γ-aminopropyltrimethoxysilane was used in place of phenyltrimethoxysilane, and that 6.81 g (0.10 mol) of sodium ethoxide was used in place of sodium methoxide, and that 37.1 g (0.10 mol) of ethyltriphenylphosphonium bromide was used in place of tetraphenylphosphonium bromide, whereby Compound G10 was obtained as purified crystals. Compound G10 was analyzed by ¹H-NMR, mass spectrum and elemental analysis. It has been confirmed by the analysis results that Compound G10 thus obtained was phosphonium silicate represented by the below-described formula (16). The yield of Compound G10 thus obtained was 85%.

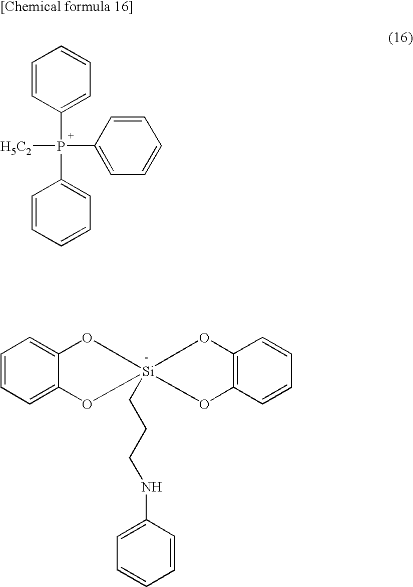

### Comparative Example 1

In a separable flask (volume: 500 mL) equipped with a condenser and a stirrer were charged 32.0 g (0.20 mol) of 2,3-dihydroxynaphthalene, 19.6 g (0.10 mol) of 3-mercaptopropyltrimethoxysilane and 150 mL of ethanol and they were dissolved uniformly under stirring. A solution obtained in advance by dissolving 4.00 g (0.10 mol) of sodium hydroxide in 20 mL of pure water was added dropwise into the flask under stirring. Another solution obtained in advance by dissolving 41.9 g (0.10 mol) of tetraphenylphosphonium bromide in 100 mL of ethanol was then gradually added dropwise into the flask to precipitate crystals. The crystals thus precipitated were purified by filtration, washing with water and vacuum drying to yield crystals.

The product thus obtained was analyzed by ¹H-NMR, mass spectrum and elemental analysis. It has been confirmed by the analysis results that the product had a similar structure to that of the phosphonium silicate of the formula (7) obtained in Example 1. The yield of the product was 72%.

### Comparative Example 2

Synthesis was performed in the same manner as in Comparative Example 1, except that 23.6 g (0.10 mol) of 3-glycidyloxypropyltrimethoxysilane was used in place of 3-mercaptopropyltrimethoxysilane, whereby purified crystals were obtained.

The resulting product was analyzed by ¹H-NMR, mass spectrum and elemental analysis. It has been confirmed by the analysis results that the product thus obtained had a similar structure to that of the phosphonium silicate of the formula (8) obtained in Example 2. The yield of the product was 69%.

### Comparative Example 3

Synthesis was performed in the same manner as in Comparative Example 1, except that 43.5 g (0.10 mol) of 3-hydroxyphenyltriphenylphosphonium bromide was used in place of tetraphenylphosphonium bromide, whereby purified crystals were obtained.

The resulting product was analyzed by ¹H-NMR, mass spectrum and elemental analysis. It has been confirmed by the analysis results that the product had a similar structure to that of the phosphonium silicate of the formula (9) obtained in Example 3. The yield of the product was 67%.

### Comparative Example 4

Synthesis was performed in the same manner as in Comparative Example 3, except that 19.8 g (0.10 mol) of phenyltrimethoxysilane was used in place of 3-mercaptopropyltrimethoxysilane, whereby purified crystals were obtained.

The resulting product was analyzed by ¹H-NMR, mass spectrum and elemental analysis. It has been confirmed by the analysis results that product thus obtained had a similar structure to that of the phosphonium silicate of the formula (10) obtained in Example 4. The yield of the product was 78%.

Synthesis and analysis results in Examples 1 to 10 and Comparative Examples 1 to 4 are summarized in Tables 1 and 2.

TABLE 1

| | Examples | | | | | | |
|---|---|---|---|---|---|---|---|
| | 1 | 2 | 3 | 4 | 5 | 6 | 7 |
| Synthesized catalyst | G1 | G2 | G3 | G4 | G5 | G6 | G7 |
| Component (A) Proton donor fed (mol) | | | | | | | |
| 2,3-Dihydroxynaphthalene | 0.2 | 0.2 | 0.2 | 0.2 | 0.2 | 0.2 | |
| Catechol | | | | | | | 0.2 |
| Component (B) Trialkoxysilane fed (mol) | | | | | | | |
| 3-Mercaptopropyltrimethoxysilane | 0.1 | | 0.1 | | | | |
| 3-Glycidyloxypropyltrimethoxysilane | | 0.1 | | | | | |
| Phenyltrimethoxysilane | | | | 0.1 | 0.1 | 0.1 | 0.1 |
| Component (C) Metal alkoxide fed (mol) | | | | | | | |
| Sodium methoxide | 0.1 | 0.1 | 0.1 | 0.1 | 0.1 | 0.1 | 0.1 |
| Sodium ethoxide | | | | | | | |
| Component (D) Phosphonium salt fed (mol) | | | | | | | |
| Tetraphenylphosphonium bromide | 0.1 | 0.1 | | | | 0.1 | 0.1 |
| 3-Hydroxyphenyltriphenylphosphonium bromide | | | 0.1 | 0.1 | | | |
| 2,5-Dihydroxyphenyltriphenylphosphonium chloride | | | | | 0.1 | | |
| Yield (%) | 91 | 88 | 89 | 92 | 90 | 96 | 91 |
| Melting point (° C.) | 176 | 146 | 128 | 239 | 294 | 271 | 125 |
| MS spectrum | | | | | | | |
| (m/z)+ | 339 | 339 | 355 | 355 | 371 | 339 | 339 |
| (m/z)− | 420 | 460 | 420 | 422 | 422 | 422 | 321 |
| Elemental analysis (%)* | | | | | | | |
| C | 74.3 | 75.1 | 72.8 | 77.3 | 75.8 | 78.9 | 76.2 |
| | (74.4) | (75.2) | (72.8) | (77.3) | (75.7) | (78.9) | (76.3) |
| H | 5.1 | 5.2 | 5.0 | 4.7 | 4.8 | 4.9 | 4.9 |
| | (5.2) | (5.4) | (5.1) | (4.8) | (4.7) | (4.9) | (5.0) |
| P | 4.2 | 3.9 | 4.0 | 4.1 | 3.8 | 4.0 | 4.8 |
| | (4.1) | (3.9) | (4.0) | (4.0) | (3.9) | (4.1) | (4.7) |
| S | 4.2 | | 4.0 | | | | |
| | (4.2) | | (4.1) | | | | |
| Si | 3.8 | 3.6 | 3.7 | 3.7 | 3.5 | 3.7 | 4.3 |
| | (3.7) | (3.5) | (3.6) | (3.6) | (3.5) | (3.7) | (4.3) |

*Numerals in ( ) are theoretical values.

TABLE 2

| | Examples | | | Comparative Examples | | | |
|---|---|---|---|---|---|---|---|
| | 8 | 9 | 10 | 1 | 2 | 3 | 4 |
| Synthesized catalyst | G8 | G9 | G10 | G1 | G2 | G3 | G4 |
| Component (A) Proton donor fed (mol) | | | | | | | |
| 2,3-Dihydroxynaphthalene | | | | 0.2 | 0.2 | 0.2 | 0.2 |
| Catechol | | 0.2 | 0.2 | | | | |
| 1,8-Dihydroxynaphthalene | 0.2 | | | | | | |
| Component (B) Trialkoxysilane fed (mol) | | | | | | | |
| 3-Mercaptopropyltrimethoxysilane | | | | 0.1 | | 0.1 | |
| 3-Glycidyloxypropyltrimethoxysilane | | | | | 0.1 | | |
| Phenyltrimethoxysilane | | | | | | | 0.1 |
| Phenyltriethoxysilane | 0.1 | | | | | | |
| 1-Naphthyltrimethoxysilane | | 0.1 | | | | | |
| N-phenyl-γ-aminopropyltrimethoxysilane | | | 0.1 | | | | |
| Component (C) Metal alkoxide fed (mol) | | | | | | | |
| Sodium methoxide | 0.1 | | 0.1 | | | | |
| Sodium ethoxide | | 0.1 | | | | | |
| Sodium hydroxide fed (mol) | | | | 0.1 | 0.1 | 0.1 | 0.1 |
| Component (D) Phosphonium salt fed (mol) | | | | | | | |
| Tetraphenylphosphonium bromide | 0.1 | 0.1 | | 0.1 | 0.1 | | |
| 3-Hydroxyphenyltriphenylphosphonium bromide | | | | | | 0.1 | 0.1 |
| Ethyltriphenylphosphonium bromide | | | 0.1 | | | | |
| Yield (%) | 90 | 89 | 85 | 72 | 69 | 67 | 81 |
| Melting point (° C.) | 231 | 142 | 116 | 175 | 144 | 124 | 238 |
| MS spectrum | | | | | | | |
| (m/z)+ | 339 | 339 | 291 | 339 | 339 | 355 | 355 |
| (m/z)− | 422 | 371 | 378 | 420 | 460 | 420 | 422 |
| Elemental analysis (%)* | | | | | | | |
| C | 78.8 | 77.6 | 73.3 | 74.6 | 75.3 | 72.9 | 77.5 |
| | (78.9) | (77.7) | (73.5) | (74.4) | (75.2) | (72.8) | (77.3) |
| H | 5.0 | 4.9 | 5.9 | 5.0 | 5.1 | 4.9 | 4.6 |
| | (4.9) | (5.0) | (6.0) | (5.2) | (5.4) | (5.1) | (4.8) |
| N | | | 2.0 | | | | |
| | | | (2.1) | | | | |
| P | 4.0 | 4.3 | 4.7 | 4.0 | 3.8 | 4.1 | 4.1 |
| | (4.1) | (4.4) | (4.6) | (4.1) | (3.9) | (4.0) | (4.0) |
| S | | | | 4.3 | | 4.1 | |
| | | | | (4.2) | | (4.1) | |
| Si | 3.8 | 3.9 | 4.3 | 3.9 | 3.7 | 3.8 | 3.8 |
| | (3.7) | (4.0) | (4.2) | (3.7) | (3.5) | (3.6) | (3.6) |

*Numerals in ( ) are theoretical values.

Examples 1 to 10 each gave a good result of a yield of 85% or higher. On the other hand, Comparative Examples 1 to 4 each gave a yield of less than 80%, which is lower than those of the Examples. In Comparative Examples, since a sodium hydroxide solution was used as a neutralizing alkali species, trialkoxysilane which is a reactive component contacts water in the sodium hydroxide solution under an alkali condition. This causes a hydrolysis reaction and a condensation reaction, thereby unfavorably lowering a yield of the target product relatively. In addition, there is a possibility that a condensation polymerized product of trialkoxysilane may mix in the target product as an impurity, thus being unfavorable.

### [Preparation of Epoxy Resin Composition and Manufacture of Semiconductor Device]

Epoxy resin compositions containing the above-described Compounds G1 to G10 were prepared in the below-described manner and then, semiconductor devices were manufactured using them.

### Example 11

A biphenyl epoxy resin (“YX-4000HK”, trade name; product of Japan Epoxy Resins Co., Ltd.) as Compound (E), a phenol aralkyl resin (“XLC-LL”, trade name; product of Mitsui Chemicals, Inc.) as Compound (F), Compound G1 as the latent catalyst (G), spherical fused silica (average particle size: 15 μm) as the inorganic filler (H) and, as additives, carbon black, brominated bisphenol A epoxy resin and carnauba wax were prepared, respectively.

The, 52 parts by weight of the biphenyl epoxy resin, 48 parts by weight of the phenol aralkyl resin, 3.79 parts by weight of Compound G1, 730 parts by weight of spherical fused silica, 2 parts by weight of carbon black, 2 parts by weight of brominated bisphenol A epoxy resin, and 2 parts by weight of carnauba wax were mixed at room temperature. The resulting mixture was then kneaded by a heated roll at 95° C. for 8 minutes, followed by grinding under cooling to yield an epoxy resin composition (thermosetting resin composition).

By using the resulting epoxy resin composition as a molding resin, eight 100-pin TQFP packages (semiconductor devices) and fifteen 16-pin DIP packages (semiconductor devices) were manufactured.

The 100-pin TQFP packages were manufactured by transfer molding at a mold temperature of 175° C. under an injection pressure of 7.4 MPa for a curing time of 2 minutes, followed by post-curing at 175° C. for 8 hours.

The 100-pin TQFP packages each had a size of 14×14 mm and a thickness of 1.4 mm, a silicon chip (semiconductor element) had a size of 8.0×8.0 mm, and a lead frame was made of a 42-alloy.

The 16-pin DIP packages, on the other hand, were manufactured by transfer molding at a mold temperature of 175° C. under an injection pressure of 6.8 MPa for a curing time of 2 minutes, followed by post-curing at 175° C. for 8 hours.

The 16-pin DIP packages each had a size of 6.4×19.8 mm and a thickness of 3.5 mm, a silicon chip (semiconductor element) had a size of 3.5×3.5 mm and a lead frame was made of a 42-alloy.

### Example 12

A biphenyl aralkyl epoxy resin (“NC-3000”, trade name; product of Nippon Kayaku Co., Ltd.) as Compound (E), a biphenyl aralkyl phenolic resin (“MEH-7851SS”, trade name; product of Meiwa Plastic Industries, Ltd.) as Compound (F), Compound G1 as the latent catalyst (G), spherical fused silica (an average particle size: 15 μm) as the inorganic filler (H), and carbon black, brominated bisphenol A epoxy resin and carnauba wax as the other additives were prepared respectively.

Next, 57 parts by weight of the biphenyl aralkyl epoxy resin, 43 parts by weight of the biphenyl aralkyl phenolic resin, 3.79 parts by weight of Compound G1, 650 parts by weight of spherical fused silica, 2 parts by weight of carbon black, 2 parts by weight of brominated bisphenol A epoxy resin, and 2 parts by weight of carnauba wax were mixed at room temperature. The resulting mixture was then kneaded using a heated roll at 105° C. for 8 minutes, followed by grinding under cooling to yield an epoxy resin composition (thermosetting resin composition).

Using the resulting epoxy resin composition, packages (semiconductor devices) were manufactured in the same manner as in Example 11.

### Example 13

An epoxy resin composition (thermosetting resin composition) was prepared in the same manner as in Example 11, except that 3.99 parts by weight of Compound G2 was used in place of Compound G1. Using the epoxy resin composition, packages (semiconductor devices) were manufactured in the same manner as in Example 11.

### Example 14

An epoxy resin composition (thermosetting resin composition) was prepared in the same manner as in Example 12, except that 3.99 parts by weight of Compound G2 was used in place of Compound G1. Using the epoxy resin composition, packages (semiconductor devices) were manufactured in the same manner as in Example 12.

### Example 15

An epoxy resin composition (thermosetting resin composition) was prepared in the same manner as in Example 11, except that 3.87 parts by weight of Compound G3 was used in place of Compound G1. Using the epoxy resin composition, packages (semiconductor devices) were manufactured in the same manner as in Example 11.

### Example 16

An epoxy resin composition (thermosetting resin composition) was prepared in the same manner as in Example 12, except that 3.87 parts by weight of Compound G3 was used in place of Compound G1. Using the epoxy resin composition, packages (semiconductor devices) were manufactured in the same manner as in Example 12.

### Example 17

An epoxy resin composition (thermosetting resin composition) was prepared in the same manner as in Example 11, except that 3.89 parts by weight of Compound G4 was used in place of Compound G1. Using the epoxy resin composition, packages (semiconductor devices) were manufactured in the same manner as in Example 11.

### Example 18

An epoxy resin composition (thermosetting resin composition) was prepared in the same manner as in Example 12, except that 3.89 parts by weight of Compound G4 was used in place of Compound G1. Using the epoxy resin composition, packages (semiconductor devices) were manufactured in the same manner as in Example 12.

### Example 19

An epoxy resin composition (thermosetting resin composition) was prepared in the same manner as in Example 11, except that 3.96 parts by weight of Compound G5 was used in place of Compound G1. Using the epoxy resin composition, packages (semiconductor devices) were manufactured in the same manner as in Example 11.

### Example 20

An epoxy resin composition (thermosetting resin composition) was prepared in the same manner as in Example 12, except that 3.96 parts by weight of Compound G5 was used in place of Compound G1. Using the epoxy resin composition, packages (semiconductor devices) were manufactured in the same manner as in Example 12.

### Example 21

An epoxy resin composition (thermosetting resin composition) was prepared in the same manner as in Example 11, except that 3.80 parts by weight of Compound G6 was used in place of Compound G1. Using the epoxy resin composition, packages (semiconductor devices) were manufactured in the same manner as in Example 11.

### Example 22

An epoxy resin composition (thermosetting resin composition) was prepared in the same manner as in Example 12, except that 3.80 parts by weight of Compound G6 was used in place of Compound G1. Using the epoxy resin composition, packages (semiconductor devices) were manufactured in the same manner as in Example 12.

### Example 23

An epoxy resin composition (thermosetting resin composition) was prepared in the same manner as in Example 11, except that 3.30 parts by weight of Compound G7 was used in place of Compound G1. Using the epoxy resin composition, packages (semiconductor devices) were manufactured in the same manner as in Example 11.

### Example 24

An epoxy resin composition (thermosetting resin composition) was prepared in the same manner as in Example 12, except that 3.30 parts by weight of Compound G7 was used in place of Compound G1. Using the epoxy resin composition, packages (semiconductor devices) were manufactured in the same manner as in Example 12.

### Example 25

An epoxy resin composition (thermosetting resin composition) was prepared in the same manner as in Example 11, except that 3.80 parts by weight of Compound G8 was used in place of Compound G1. Using the epoxy resin composition, packages (semiconductor devices) were manufactured in the same manner as in Example 11.

### Example 26

An epoxy resin composition (thermosetting resin composition) was prepared in the same manner as in Example 12, except that 3.80 parts by weight of Compound G8 was used in place of Compound G1. Using the epoxy resin composition, packages (semiconductor devices) were manufactured in the same manner as in Example 12.

### Example 27

An epoxy resin composition (thermosetting resin composition) was prepared in the same manner as in Example 11, except that 3.55 parts by weight of Compound G9 was used in place of Compound G1. Using the epoxy resin composition, packages (semiconductor devices) were manufactured in the same manner as in Example 11.

### Example 28

An epoxy resin composition (thermosetting resin composition) was prepared in the same manner as in Example 12, except that 3.55 parts by weight of Compound G9 was used in place of Compound G1. Using the epoxy resin composition, packages (semiconductor devices) were manufactured in the same manner as in Example 12.

### Example 29

An epoxy resin composition (thermosetting resin composition) was prepared in the same manner as in Example 11, except that 3.35 parts by weight of Compound G10 was used in place of Compound G1. Using the epoxy resin composition, packages (semiconductor devices) were manufactured in the same manner as in Example 11.

### Example 30

An epoxy resin composition (thermosetting resin composition) was prepared in the same manner as in Example 12, except that 3.35 parts by weight of Compound G10 was used in place of Compound G1. Using the epoxy resin composition, packages (semiconductor devices) were manufactured in the same manner as in Example 12.

### Comparative Example 5

An epoxy resin composition (thermosetting resin composition) was prepared in the same manner as in Example 11, except that 1.31 parts by weight of triphenylphosphine was used in place of Compound G1. Using the epoxy resin composition, packages (semiconductor devices) were manufactured in the same manner as in Example 11.

### Comparative Example 6

An epoxy resin composition (thermosetting resin composition) was prepared in the same manner as in Example 12, except that 1.31 parts by weight of triphenylphosphine was used in place of Compound G1. Using the epoxy resin composition, packages (semiconductor devices) were manufactured in the same manner as in Example 12.

### Comparative Example 7

An epoxy resin composition (thermosetting resin composition) was prepared in the same manner as in Example 11, except that 1.85 parts by weight of triphenylphosphine-benzoquinone adduct was used in place of Compound G1. Using the epoxy resin composition, packages (semiconductor devices) were manufactured in the same manner as in Example 11.

### Comparative Example 8

An epoxy resin composition (thermosetting resin composition) was prepared in the same manner as in Example 12, except that 1.85 parts by weight of triphenylphosphine-benzoquinone adduct was used in place of Compound G1. Using the epoxy resin composition, packages (semiconductor devices) were manufactured in the same manner as in Example 12.

### [Evaluation of Properties]

The epoxy resin compositions obtained in Examples and Comparative Examples were evaluated for properties (1) to (3), and the semiconductor devices manufactured in Examples and Comparative Examples were evaluated for properties (4) and (5), each in the following manner.

### (1) Spiral Flow:

Using a mold for measuring spiral flow in accordance with EMMI-1-66, the spiral flow of each resin composition was measured at a mold temperature of 175° C. under an injection pressure of 6.8 MPa for a curing time of 2 minutes.

The spiral flow is a parameter of fluidity and when it is greater, the epoxy resin composition has better fluidity.

### (2) Curing Torque:

Using a curelastometer (“JSR Curelastometer IV PS Model”, trade name; product of Orientec Co., Ltd.), the torque of each resin composition after 45 seconds at 175° C. was measured.

When the curing torque is greater, the epoxy resin composition has better curing property.

### (3) Residual Flow Percentage:

The epoxy resin compositions were stored in the atmosphere at 30° C. for 1 week, and their spiral flow was measured in the same manner as in (1). The percentage (%) of the spiral flow of the stored sample relative to that immediately after preparation was determined.

When the residual flow percentage is greater, the epoxy resin composition has better storage stability.

### (4) Solder Crack Resistance:

After the 100-pin TQFP was left under an environment of 85° C. and 85% RH for 168 hours, it was dipped in a solder bath of 260° C. for 10 seconds.

Under a microscope, presence or absence of external cracks was observed. Occurrence of cracks was expressed by a percentage (%) determined in accordance with the following equation:

Crack occurrence rate=(the number of packages in which cracks have appeared)/(number of all the packages)×100.

In addition, the area ratio of the silicon chip from which the cured epoxy resin composition had been separated was measured using an ultrasonic flaw detector. In accordance with the following equation: separation ratio (%)=(separated area)/(silicon chip area)×100, an average separated area ratio of the ten packages was calculated, and expressed in terms of percentage (%).

Smaller crack occurrence percentage and separation ratio suggest that the package has better solder crack resistance.

### (5) Moisture Resistance Reliability:

A voltage of 20V was applied to the 16-pin DIP packages in a water vapor at 125° C. and 100% RH, and they were checked for interconnection failure. The time until the interconnection failure occurred in eight of fifteen packages was taken as the failure time.

The moisture resistance reliability is measured for hours at a maximum. When the number of packages in which the failure has occurred is less than 8 after a lapse of 500 hours, the failure time is indicated as greater than 500 hours (>500).

When the failure time is greater, the package has better moisture resistance reliability.

The evaluation results of properties (1) to (5) are shown in Tables 3 and 4.

### [Table 3]

TABLE 3

| | | | Examples | | | | | |
|---|---|---|---|---|---|---|---|---|
| | | | 11 | 12 | 13 | 14 | 15 | 16 |
| Composition | Compo- | YX-4000HK | 52 | | 52 | | 52 | |
| | nent (E) | NC-3000 | | 57 | | 57 | | 57 |
| | Compo- | XLC-LL | 48 | | 48 | | 48 | |
| | nent (F) | MEH-7851SS | | 43 | | 43 | | 43 |
| | Compo- | G1 | 3.79 | 3.79 | | | | |
| | nent (G) | G2 | | | 3.99 | 3.99 | | |
| | | G3 | | | | | 3.87 | 3.87 |
| | | G4 | | | | | | |
| | | G5 | | | | | | |
| | | G6 | | | | | | |
| | Compo- | Spherical fused silica | 730 | 650 | 730 | 650 | 730 | 650 |
| | nent (H) | Carbon black | 2 | 2 | 2 | 2 | 2 | 2 |
| | | Brominated bisphenol A epoxy resin | 2 | 2 | 2 | 2 | 2 | 2 |
| | | Carnauba wax | 2 | 2 | 2 | 2 | 2 | 2 |
| Properties | Spiral flow (cm) | | 131 | 128 | 138 | 130 | 136 | 133 |
| | Curing torque (N · m) | | 7.76 | 7.94 | 7.78 | 7.88 | 7.56 | 7.48 |
| | Residual flow percentage (%) | | 88 | 91 | 94 | 95 | 89 | 93 |
| | Solder resistance (the number of external cracks, %) | | 0 | 0 | 0 | 0 | 0 | 0 |
| | Solder resistance (separation ratio, %) | | 0 | 0 | 0 | 0 | 0 | 0 |
| | Moisture resistance reliability (hr) | | >500 | >500 | >500 | >500 | >500 | >500 |
| | | | Examples | | | | | |
| | | | 17 | 18 | 19 | 20 | 21 | 22 |
| Composition | Compo- | YX-4000HK | 52 | | 52 | | 52 | |
| | nent (E) | NC-3000 | | 57 | | 57 | | 57 |
| | Compo- | XLC-LL | 48 | | 48 | | 48 | |
| | nent (F) | MEH-7851SS | | 43 | | 43 | | 43 |
| | Compo- | G1 | | | | | | |
| | nent (G) | G2 | | | | | | |
| | | G3 | | | | | | |
| | | G4 | 3.89 | 3.89 | | | | |
| | | G5 | | | 3.96 | 3.96 | | |
| | | G6 | | | | | 3.80 | 3.80 |
| | Compo- | Spherical fused silica | 730 | 650 | 730 | 650 | 730 | 650 |
| | nent (H) | Carbon black | 2 | 2 | 2 | 2 | 2 | 2 |
| | | Brominated bisphenol A epoxy resin | 2 | 2 | 2 | 2 | 2 | 2 |
| | | Carnauba wax | 2 | 2 | 2 | 2 | 2 | 2 |

| | | | | | | | |
|---|---|---|---|---|---|---|---|
| Properties | Spiral flow (cm) | 139 | 136 | 140 | 142 | 138 | 143 |
| | Curing torque (N · m) | 7.28 | 7.33 | 7.06 | 7.11 | 7.43 | 7.58 |
| | Residual flow percentage (%) | 94 | 96 | 93 | 95 | 95 | 97 |
| | Solder resistance (the number of external cracks, %) | 0 | 0 | 0 | 0 | 0 | 0 |
| | Solder resistance (separation ratio, %) | 0 | 0 | 0 | 0 | 0 | 0 |
| | Moisture resistance reliability (hr) | >500 | >500 | >500 | >500 | >500 | >500 |

TABLE 4

| | | | Examples | | | | | |
|---|---|---|---|---|---|---|---|---|
| | | | 23 | 24 | 25 | 26 | 27 | 28 |
| Composition | Compo- | YX-4000HK | 52 | | 52 | | 52 | |
| | nent (E) | NC-3000 | | 57 | | 57 | | 57 |
| | Compo- | XLC-LL | 48 | | 48 | | 48 | |
| | nent (F) | MEH-7851SS | | 43 | | 43 | | 43 |
| | Compo- | G7 | 3.30 | 3.30 | | | | |
| | nent (G) | G8 | | | 3.80 | 3.80 | | |
| | | G9 | | | | | 3.55 | 3.55 |
| | | G10 | | | | | | |
| | | Triphenylphosphine | | | | | | |
| | | Triphenylphosphine/p-benzoquinone | | | | | | |
| | | adduct | | | | | | |
| | Compo- | Spherical fused silica | 730 | 650 | 730 | 650 | 730 | 650 |
| | nent (H) | Carbon black | 2 | 2 | 2 | 2 | 2 | 2 |
| | | Brominated bisphenol A epoxy resin | 2 | 2 | 2 | 2 | 2 | 2 |
| | | Carnauba wax | 2 | 2 | 2 | 2 | 2 | 2 |
| Properties | Spiral flow (cm) | | 130 | 126 | 135 | 129 | 132 | 129 |
| | Curing torque (N · m) | | 7.38 | 7.26 | 7.66 | 7.49 | 7.51 | 7.58 |
| | Residual flow percentage (%) | | 90 | 93 | 94 | 96 | 92 | 94 |
| | Solder resistance (the number of external cracks, %) | | 0 | 0 | 0 | 0 | 0 | 0 |
| | Solder resistance (separation ratio, %) | | 0 | 0 | 0 | 0 | 0 | 0 |
| | Moisture resistance reliability (hr) | | >500 | >500 | >500 | >500 | >500 | >500 |
| | | | Examples | | Comparative Examples | | | |
| | | | 29 | 30 | 5 | 6 | 7 | 8 |
| Composition | Compo- | YX-4000HK | 52 | | 52 | | 52 | |
| | nent (E) | NC-3000 | | 57 | | 57 | | 57 |
| | Compo- | XLC-LL | 48 | | 48 | | 48 | |
| | nent (F) | MEH-7851SS | | 43 | | 43 | | 43 |
| | Compo- | G7 | | | | | | |
| | nent (G) | G8 | | | | | | |
| | | G9 | | | | | | |
| | | G10 | 3.35 | 3.35 | | | | |
| | | Triphenylphosphine | | | 1.31 | 1.31 | | |
| | | Triphenylphosphine/p-benzoquinone | | | | | 1.85 | 1.85 |
| | | adduct | | | | | | |
| | Compo- | Spherical fused silica | 730 | 650 | 730 | 650 | 730 | 650 |
| | nent (H) | Carbon black | 2 | 2 | 2 | 2 | 2 | 2 |
| | | Brominated bisphenol A epoxy resin | 2 | 2 | 2 | 2 | 2 | 2 |
| | | Carnauba wax | 2 | 2 | 2 | 2 | 2 | 2 |

| | | | | | | | |
|---|---|---|---|---|---|---|---|
| Properties | Spiral flow (cm) | 128 | 124 | 72 | 63 | 105 | 99 |
| | Curing torque (N · m) | 7.48 | 7.54 | 6.28 | 6.05 | 7.02 | 7.10 |
| | Residual flow percentage (%) | 89 | 92 | 72 | 78 | 80 | 83 |
| | Solder resistance (the number of external cracks, %) | 0 | 0 | 10 | 0 | 10 | 5 |
| | Solder resistance (separation ratio, %) | 0 | 0 | 10 | 5 | 10 | 5 |
| | Moisture resistance reliability (hr) | >500 | >500 | >500 | >500 | 480 | 480 |

As shown in Table 2, the epoxy resin compositions (epoxy resin compositions containing the latent catalyst obtained by the invention) obtained in Examples 11 to 30 each exhibited good curing property, fluidity and storage stability and in addition, packages (semiconductor devices of the invention) of each Example encapsulated with the cured product of the above-described epoxy resin composition had good solder crack resistance and moisture resistance reliability.

The epoxy resin compositions obtained in Comparative Examples 5 to 8, on the other hand, are each inferior in storage stability and fluidity and packages manufactured in these comparative examples are relatively inferior in solder crack resistance and moisture resistance reliability.

While the present invention has been described in detail and with reference to specific embodiments thereof, it will be apparent to one skilled in the art that various changes and modifications can be made therein without departing from the spirit and scope thereof.

This application is based on Japanese Patent Application No. 2005-280517 filed Sep. 27, 2005, the contents thereof being herein incorporated by reference.

### INDUSTRIAL APPLICABILITY

The present invention makes it possible to prepare, in a high yield, a latent catalyst which does not contain by-products therein, does not exert a catalytic activity at normal temperature, renders a resin composition stably storable for a long period of time, and exerts an excellent catalytic activity at a molding temperature. An epoxy resin composition containing such a latent catalyst is useful for encapsulating electronic parts such as semiconductor elements therewith.

1. A preparation process of a phosphonium silicate latent catalyst, which comprises reacting (A) a proton donor represented by the following formula (1):
[Chemical Formula 1]
HY¹-Z¹-Y²H (1)
[wherein Y¹ and Y² may be the same or different and each represents a group resulting from a proton donating substituent through release of a proton, Z¹ represents a substituted or unsubstituted organic group which bonds to proton donating substituents Y¹H and Y²H, and two substituents Y¹ and Y² in the same molecule are capable of bonding to a silicon atom to form a chelate structure], (B) a trialkoxysilane compound and (D) a phosphonium salt compound represented by the following formula (2): 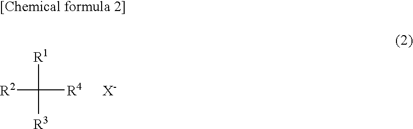
[wherein R¹, R², R³ and R⁴ may be the same or different and each represents an organic group having a substituted or unsubstituted, aromatic or heterocyclic ring or represents a substituted or unsubstituted aliphatic group and X⁻ represents a halide ion, a hydroxide ion or an anion resulting from a proton donating group through release of a proton],
wherein the reaction is carried out in the presence of (C) a metal alkoxide compound.

2. The preparation process of a phosphonium silicate latent catalyst according to claim 1, wherein the proton donor (A) represented by the formula (1) and the trialkoxysilane compound (B) are allowed to react in advance in an organic solvent in the presence of the metal alkoxide compound (C).

3. The preparation process of a phosphonium silicate latent catalyst according to claim 1, wherein the proton donor (A) represented by the formula (1) is an aromatic dihydroxy compound represented by the following formula (3):
[Chemical Formula 3]
HO-Ar¹-OH (3)
[wherein Ar¹ represents an organic group having a substituted or unsubstituted, aromatic or heterocyclic ring and two oxygen anions resulting from two OH groups on the organic group Ar¹ through release of a proton are capable of bonding to a silicon atom to form a chelate structure].

4. The preparation process of a phosphonium silicate latent catalyst according to claim 1 wherein the phosphonium salt compound (D) represented by the formula (2) is a quaternary phosphonium salt compound represented by the following formula (4): 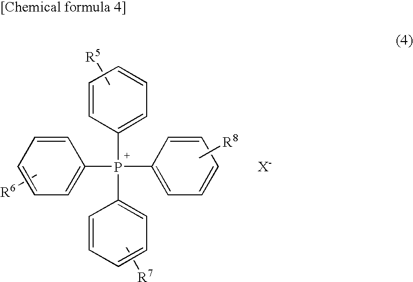
[wherein R⁵, R⁶, R⁷ and R⁸ may be the same or different and each represents one member selected from hydrogen atom, methyl group, methoxy group and hydroxyl group, and X⁻ represents a halide ion, a hydroxide ion or an anion, resulting from a proton donating group through release of a proton].

5. The preparation process of a phosphonium silicate latent catalyst according to claim 1, wherein the phosphonium silicate latent catalyst is a phosphonium silicate compound represented by the following formula (5): 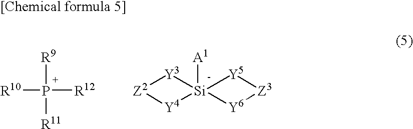
[wherein R⁹, R¹⁰, R¹¹ and R¹² may be the same or different and each represents an organic group having a substituted or unsubstituted, aromatic or heterocyclic ring, or a substituted or unsubstituted aliphatic group, Y³, Y⁴, Y⁵ and Y⁶ each represents a group resulting from a proton donating substituent through release of a proton, Z² represents a substituted or unsubstituted organic group which bonds to Y³ and Y⁴, two substituents Y³ and Y⁴ in the same molecule are capable of bonding to a silicon atom to form a chelate structure, Z³ represents a substituted or unsubstituted organic group which bonds to Y⁵ and Y⁶, and two substituents Y⁵ and Y⁶ in the same molecule are capable of bonding to a silicon atom to form a chelate structure, and A¹ represents an organic group].

6. The preparation process of a phosphonium silicate latent catalyst according to claim 4, wherein the phosphonium silicate latent catalyst is a phosphonium silicate compound represented by the following formula (6): 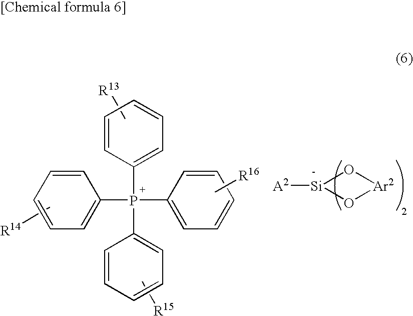
[wherein R¹³, R¹⁴, R¹⁵ and R¹⁶ may be the same or different and each represents one member selected from a hydrogen atom, a methyl group, a methoxy group and a hydroxyl group, Ar² represents an organic group having a substituted or unsubstituted, aromatic or heterocyclic ring, two oxygen anions resulting from two OH groups on the organic group Ar² through release of a proton are capable of bonding to a silicon atom to form a chelate structure, and A² represents an organic group].

7. An epoxy resin composition comprising (E) a compound having, in one molecule thereof, at least two epoxy groups, (F) a compound having, in one molecule thereof, at least two phenolic hydroxyl groups, and (G) a phosphonium silicate latent catalyst obtained by the preparation process as claimed in claims 1 to 6.
